(19) United States
(12) Patent Application Publication
(10) Pub. No.: US 2024/0100953 A1
(43) Pub. Date: Mar. 28, 2024

(54) MULTI-TYPE CONFIGURABLE DISPLAY GAUGE

(71) Applicant: CATERPILLAR INC., Peoria, IL (US)

(72) Inventors: Ming HE, Wuxi (CN); Xin WU, Wuxi (CN); Lin ZHANG, Wuxi (CN); Teng ZHANG, Wuxi (CN)

(73) Assignee: CATERPILLAR INC., Peoria, IL (US)

(21) Appl. No.: 18/265,884

(22) PCT Filed: Nov. 30, 2021
(86) PCT No.: PCT/US2021/061105

§ 371 Date: Jun. 7, 2023

(30) Foreign Application Priority Data
Dec. 10, 2020 (CN) 202011437658.0

(51) Int. Cl. B60K 37/02

(52) U.S. Cl. CPC B60K 37/02; B60K 2370/178; B60K 2370/27; B60K 2370/336; B60K 2370/341; B60K 2370/52; B60K 2370/695

(57) ABSTRACT

The present invention relates to a display gauge, particularly used in a cab of a motor vehicle. The display gauge comprises a display unit and a control unit, the display unit having a stationary warning zone, the control unit being connectable with different types of sensors to receive sensor signals, wherein the display gauge further comprises a coded selector that can be operated by a user, the selector being electrically connected to the control unit to transmit to the control unit a signal indicative of a type of a current sensor signal selected by the user, and the control unit controls display of the display unit according to a value of the current sensor signal, so that a state in which the value of the current sensor signal reaches a warning value range can be displayed through the warning zone regardless of the type of the sensor. The present invention allows to display multiple types of sensor signals by a single display gauge, and to exhibit different functions or sensor signal types with different symbols or icons.

### TECHNICAL FIELD

The present invention relates to a display gauge, in particular to a display gauge used in a cab of a motor vehicle such as an engineering machine.

### BACKGROUND ART

Display gauges are widely used in various fields. They are usually used to display the values of specific parameters, such as temperature and pressure, in real time during the operation of the equipment, so as to indicate to the user the current status of the equipment. In order to ensure the safety of operation, the user often needs to pay attention to whether the relevant parameter is close to or in range of warning value (i.e. the value that needs to be paid attention to by the user, which may be close to or even reach the limit value of the relevant parameter), i.e. whether the display of the gauge is in the warning zone (also known as “red zone”). The existing display gauges are generally uni-functional gauges with fixed icons, that is, a display gauge can only be used to display a single type of parameter (such as temperature or pressure). In addition, since the uni-functional gauges have different red zones, different applications need different product models, resulting in diversified product models. This brings difficulties to both gauge manufacturers and gauge users.

The document CN208902310U discloses a pressure gauge with adjustable indication intervals. The pressure gauge includes a pressure gauge body, a pointer connected to the front end of the pressure gauge body, and three pairs of arc-shaped or ring-shaped bars with different colors (red, yellow, and green) arranged in the pressure gauge body, wherein the red and yellow pairs of arc-shaped bars can slide in their respective sliding grooves to automatically adjust the indication intervals of pressure segments of different colors, and quickly determine the state of the measured parameter value.

However, the gauge disclosed in the above document is a mechanical gauge, which has been eliminated in many applications, such as motor vehicles, due to the defects such as poor accuracy and easy wear. At present, an electronic display gauge comprising a processor control unit and a physical or digital pointer is adopted in many application fields. As mentioned above, the existing display gauges (especially those with physical pointers) have the defect that a single gauge cannot display red zones of different parameters.

### SUMMARY OF THE INVENTION

The present invention relates to a display gauge, particularly used in a cab of a motor vehicle. The display gauge comprises a display unit and a control unit, the display unit having a stationary/fixed warning zone, the control unit being connectable with different types of sensors to receive sensor signals such as signals of temperature, pressure, liquid level, etc., wherein the display gauge further comprises a coded/programmable selector that can be operated by a user, the selector being electrically connected to the control unit to transmit to the control unit a signal indicative of a type of a current sensor signal selected by the user, and the control unit controls display of the display unit according to a value of the current sensor signal, so that a state in which the value of the current sensor signal reaches a warning value range can be displayed through the warning zone regardless of the type of the sensor.

### BRIEF DESCRIPTION OF THE DRAWINGS

FIG. 1 is a cross-sectional view of a display gauge according to an embodiment of the present invention;

FIG. 2 shows a dial of a display gauge according to an embodiment of the present invention; and

FIG. 3 is a bottom view of the display gauge shown in FIGS. 1 and 2.

### DETAILED DESCRIPTION OF THE EMBODIMENTS

Embodiments of the present invention will be described in the following with reference to the drawings.

The display gauge of the present invention, which can be used in various fields such as industry and daily life, can display the values of specific parameters of related equipment to the user in real time, so that the user can timely and intuitively know the current status of the related equipment and know whether the parameter is close to or in the warning value range. The display gauge of the present invention is particularly used in the driver's cab of a motor vehicle, for example, an engineering machine. In particular, the display gauge of the present invention comprises a scale visible to the user and a pointer for pointing different zones of the scale. The pointer is particularly a physical (entity/solid) pointer, and the scale is particularly a physical scale. Of course, the pointer and the scale may also be virtual pointer and scale that are displayed electronically.

The basic idea of the present invention is to display different values of different types of parameters, especially to indicate to the user that the value of the parameter is close to or enters into the warning value range by means of one and the same gauge, especially a single set of pointer and scale. In other words, when different types of parameters with different value ranges (especially different warning value ranges) enter their warning value ranges, the display gauge of the present invention can display or indicate this situation to the user by making the same pointer point to the same warning zone (i.e. “red zone”) of the same scale.

Specifically, the display gauge of the present invention comprises a control unit that can be signal-connected to different types of sensors, and a display unit signal-connected to the control unit. The control unit is configured to receive, for example via a CAN bus, and process sensor signals indicative of different types of parameters such as temperature, pressure, or liquid level, and can control the display of the display unit according to the sensor signal selected by the user (i.e., the current signal of the uni-functional sensor connected to the control unit) to notify the user of the real-time situation of the selected sensor signal, e.g. the real-time value or value range and whether it is close to or reaches the warning value. The display unit is configured to display the real-time situation of the selected sensor signal in a manner visible to the user as a function of the signal received by the control unit, in particular, to show, by the stationary warning zone (red zone), that the parameter indicative of the selected sensor signal has reached the warning value zone. According to the present invention, the sensor signal can be selected by the user using the coded selector that is signal-connected to the control unit.

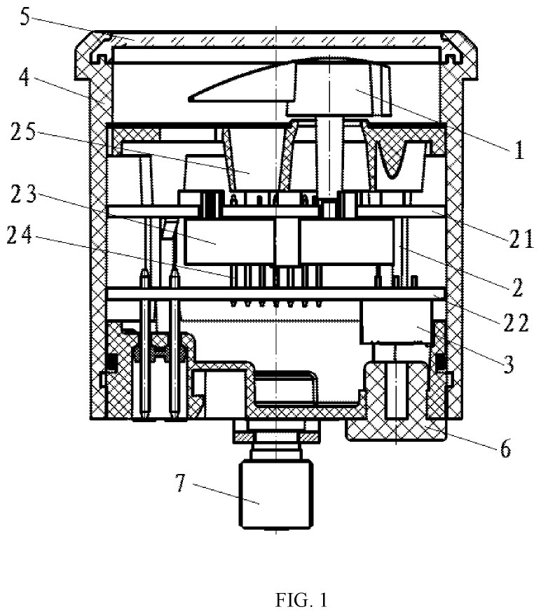

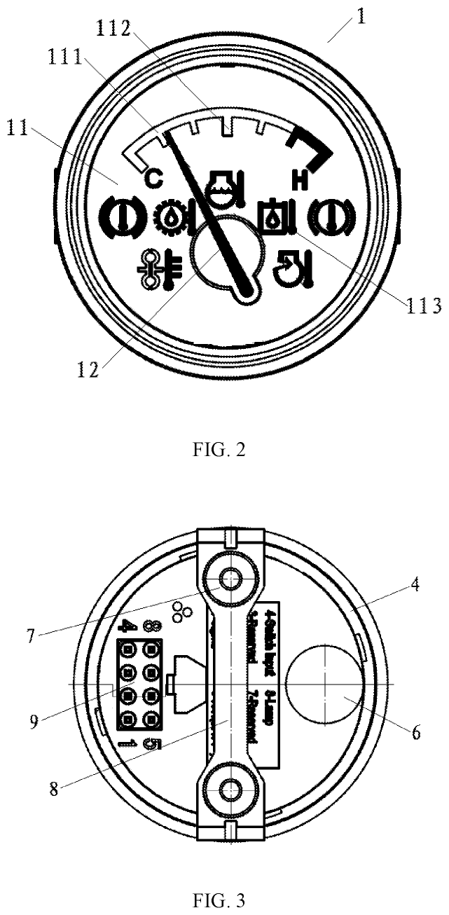

Referring to FIGS. 1-2, the display unit 1 comprises a dial 11 and a pointer 12 which is visible from the upper surface (the upward surface in FIG. 1, i.e. the surface visible to the user during the use of the display gauge) of the dial 11. As shown in FIG. 2, the dial 11 is provided with a scale, e.g. by printing. The scale may include a plurality of sections, in which the section at the end, particularly in the clockwise direction, forms a warning section. The warning section may have different features, particularly colors such as red color, from other sections of the scale. The pointer 12 is mounted to pivot relative to the scale on the dial 11 to point to different scale sections in accordance with the status of the current sensor signal. In particular, the pointer 12 can have a remarkable appearance feature, for example, a red color.

According to the embodiment shown in FIG. 2, the scale of the dial 11 may include an arc line 111 having a certain width and scale lines 112. The arc line 111 may be centered on the pivot point of the pointer 12 and have an extension of, for example, 90 degrees. The scale lines 112 extend in the radial direction with respect to the arc line 111 to divide the latter into a plurality of sections, for example, 6 sections, wherein the warning section at the end can be marked with a warning sign, e.g. a letter “H (High)”. In particular, the scale is not provided with specific values, but is only divided into multiple sections including a warning section.

Preferably, the dial 11 is composed of a dark transparent film and has a plurality of functional symbols 113 indicative of the types of sensor signals to be displayed. Due to the characteristics of the dark transparent film, these function symbols 113 are visible to the user only when they are lightened. In particular, these function symbols 113 are designed to be lightened in correspondence to the current sensor signal type selected by the user.

Still referring to FIGS. 1 and 2, the control unit 2 may include a microprocessor, e.g. a single-chip microcomputer of the model STM32F103C4T6 available in the market. In the microprocessor, software processing modules respectively for processing different types of sensor signals are stored, which are especially used to convert voltage values as a function of the sensor signals into digital values, and to generate corresponding pulses as outputs by the setting of the software so as to drive a stepping motor. According to the present invention, the software processing modules in the microprocessor are activated by a coded selector.

To this end, the microprocessor is electrically connected to the coded selector 3 at an input port. The selector 3 can be operated by the user to generate different codes, so as to inform the microprocessor of the type of sensor signal that should be processed currently, that is, the software processing module that should be run. In particular, the selector 3 can generate 16-bit codes from 0000 to 1111. Here, preferably, the selector 3 is a potentiometer, particularly a 16-bit potentiometer. Of course, the selector 3 may also be other codeable devices, e.g. a dial switch.

The selector 3 is particularly graded according to the resistance value measured by the sensor. For example, in grade I, a coded value notifies the microprocessor that the sensor signal related to a resistance level of a certain Ω should be displayed by the warning zone of the display unit 1; in grade II, another coded value notifies the microprocessor that the sensor signal related to the resistance level of a certain KΩ should be displayed by the warning zone of the display unit 1. The graded matching between the selector 3 and the microprocessor can be implemented through hardware and software. This can be implemented by those skilled in the art according to the actual situation, and will not be described in detail here.

Of course, the selector 3 can also be graded according to the current value, in order to notify the microprocessor that the partial pressure sensor measurement signal related to a certain current value level should be displayed in the warning zone of the display unit 1.

The control unit 2 may also include a module for driving the pointer 12 to pivot, and the module may include a stepping motor 23 and a corresponding electric circuit. The stepping motor 23 may drive the pointer 12 based on the aforementioned pulse signal, so that the pointer 12 can be pivoted step by step. The electric circuit may be formed, for example, by a VID66-08 driving chip available on the market, and may be signal-connected to the microprocessor via pins 24 so as to receive control signals from the microprocessor. Of course, it is also possible not to use a separate drive chip, but to use other microprocessors that are directly integrated with such a driving electric circuit and are different from the single-chip microcomputer in model.

As can be seen particularly from FIG. 1, the control unit 2 may also include a plurality of guides of light, also called “light guides” 25. The light guides 25 are formed, for example, by a light shell having a substantially cylindrical or conical light channel, and each of the light guides is aligned with a light emitting device, e.g. an LED, of the control unit 2 at one end, and is oriented toward a function symbol 113 of the display unit 1 at the other end. The light guides 25 are used to light up respective function symbols 113 as a function of the type of current sensor signal selected by the user.

As shown in FIG. 1, preferably, the control unit 2 may be formed by two circuit boards placed one on the other. A portion of the control unit 2 that is directly related to the display unit 1, especially the light guides 25 and the stepping motor 23 and its driving circuit, may be arranged on the upper circuit board 21, wherein the light guides 25 may be arranged on the upper surface of the upper circuit board 21, the stepping motor 23 and its driving circuit may be arranged on the lower surface of the upper circuit board 21 and connected to and drive the pointer 12 via a pivot shaft passing through the upper circuit board 21. The rest of the control unit 2, especially the microprocessor, can be arranged on the lower circuit board 22 and, for example, signal-connected to components on the upper circuit board 21 via pins 24.

In this case, the selector 3 can be arranged on the lower surface of the lower circuit board 22 of the control unit 2, so as to be electrically connected with the microprocessor of the control unit 1 on the one hand, and accessible and operated by the user on the other hand.

According to the illustrated embodiment, the display gauge of the present invention may include a housing 4, especially an integrally injection-molded housing, for encapsulating the display unit 1, the control unit 2 and the selector 3.

The housing 4 may, at the top, be open and sealed by a transparent PC plate 5, so as to protect the dial 11 and the pointer 12 of the display unit 1 on the one hand, and allow the user to clearly see the indication of the pointer 12 relative to the scale of the dial 11 on the other hand.

The housing 4 may, at the bottom, be closed by an integral or separate cover, and has an opening aligned with the location of the selector 3. The opening may be closed by a removable plug 6.

As shown in FIG. 3, the display gauge of the present invention can be entirely installed on the chuck 8 of the dial via a nut 7 connected to the bottom of the housing 4. In particular, an interface 9 for function expansion can be provided at the bottom of the housing 4.

### INDUSTRIAL APPLICABILITY

With the user-adjustable coded selector 3, especially adjustable potentiometer, the display gauge of the present invention allows the user to determine and inform the control unit 1 of the type of sensor signal that should be displayed. In this way, a single display gauge can display various types of sensor signals such as temperature and pressure which have various warning ranges. Moreover, the present invention can also display different functions with different symbols or icons through a single display instrument. In addition, the display gauge of the present invention has a compact structure and can be advantageously applied to a limited space.

The display gauge of the present invention effectively solves the problem that the current suppliers have to produce different types of display gauges for different applications. The display gauge can be produced centrally at one time, thereby reducing inventory and logistics costs.

The following two examples illustrate the process of matching between the control unit and the display unit of the display gauge of the present invention.

The two examples relate to two different types of sensors that detect temperatures of different components or locations of the machine. In these examples, the scale of the dial of the display gauge is divided into 6 grids (i.e. 6 sections), each of which extends over 15 degrees, and the last grid (i.e. the section of 75 to 90 degrees) is used as a warning zone (red zone). The control unit is configured to rotate the pointer of the display unit by 1 degree every time it outputs 12 pulses.

In the two examples, the control unit, especially the single-chip microcomputer as its microprocessor, is equipped with a 12-bit precision A/D (analog/digital) conversion module, so that the analog voltage signal collected by the sensor can be converted to 2¹² (i.e., 4096) digital values, namely, digital values from 0 to 4095 (i.e. 4096−1).

Moreover, in the two examples, the microprocessor of the control unit uses a 3.3V (volts) standard reference voltage, and a 300Ω (ohm) pull-up resistor is used in the voltage divider circuit between the output of the sensor and the input of the microprocessor to convert the resistive sensor signal into a voltage that can be used by the microprocessor.

Thereby the following equations can be applied to realize the correspondence between the actual temperature of the component and the A/D conversion value derived from the microprocessor of the control unit:

DV=3.3×SR/(SR+PR) (Equation 1)

A/D=DV×4095/3.3 (Equation 2)

wherein SR refers to the sensor signal or sensor measurement value related to the actual temperature, it is a resistance value in Ω and its actual value (varies with temperature) depends on the setting of the sensor manufacturer; PR refers to the resistance value of the pull-up resistor in the voltage divider circuit, being 30052 here. DV refers to the divided voltage in V generated by the voltage divider circuit; A/D refers to the A/D conversion value (hereinafter referred to as “digital value”) resulted from the processing of the microprocessor.

### Example 1

| | | Sensor | Pull-up | Divided | A/D | |
|---|---|---|---|---|---|---|
| | Temperature | signal | resistor | voltage | conversion | Number |
| | (° C.) | SR (Ω) | PR (Ω) | DV (V) | value | of pulses |
| Warning | 40 | 1609.7 | 300 | 2.7816 | 3452 | 0 |
| temperature | 60 | 830.6 | 300 | 2.4244 | 3008 | 15 * 12 = 180 |
| 110-160° C. | 80 | 424.1 | 300 | 1.9328 | 2398 | 30 * 12 = 360 |
| | 90 | 306.9 | 300 | 1.6312 | 2024 | 45 * 12 = 540 |
| | 100 | 225.3 | 300 | 1.4154 | 1756 | 60 * 12 = 720 |
| | 110 | 175.4 | 300 | 1.2175 | 1511 | 75 * 12 = 900 |
| | 150 | 58 | 300 | 0.5346 | 663 | 90 * 12 = 1080 |

As shown in the above table, if the temperature of the measured object is 40° C., the sensor will generate a 1609.7Ω resistance signal. The resistance signal is sent to the voltage divider circuit and treated by a 300Ω pull-up resistor connected in serial therewith to generate a 2.7816V divided voltage. The divided voltage is sent to the microprocessor of the control unit, and a digital value 3452 is generated after A/D conversion. Corresponding to the digital value, the number of pulses generated by the microprocessor is zero, and the pointer of the display unit stays at the starting point of the scale.

When the temperature of the measured object reaches 60° C., the sensor generates an 830.6Ω resistance signal. After subsequent processing and conversion, a digital value 3008 is generated in the microprocessor of the control unit. Corresponding to the digital value, the microprocessor generates 180 (i.e. 15×12) pulses, so that the pointer of the display unit is rotated by 15 degrees (i.e. one grid) with regard to the scale.

When the temperature of the measured object reaches 80° C., a digital value 2398 is generated in the microprocessor of the control unit by processing and converting the resistance signal generated by the sensor. Corresponding to the digital value, the microprocessor generates 360 (i.e. 30×12) pulses, so that the pointer of the display unit is rotated by 30 degrees (i.e. 2 grids) with regard to the scale.

When the temperature of the measured object reaches 90° C., a digital value 2024 is generated in the microprocessor of the control unit by processing and converting the resistance signal generated by the sensor. Corresponding to the digital value, the microprocessor generates 540 (i.e. 45×12) pulses, so that the pointer of the display unit is rotated by 45 degrees (i.e. 3 grids) relative to the scale.

When the temperature of the measured object reaches 100° C., a digital value 1756 is generated in the microprocessor of the control unit by processing and converting the resistance signal generated by the sensor. Corresponding to the digital value, the microprocessor generates 720 (i.e. 60×12) pulses, so that the pointer of the display unit is rotated by 60 degrees (i.e. 4 grids) relative to the scale.

When the temperature of the measured object reaches 110° C., a digital value 1511 is generated in the microprocessor by processing and converting the resistance signal generated by the sensor. Corresponding to the digital value, the microprocessor generates 900 (i.e. 75×12) pulses, so that the pointer of the display unit is rotated by 75 degrees (i.e. 5 grids) relative to the scale, reaching the lower limit of the warning zone (i.e. the starting point of the warning zone).

When the temperature of the measured object reaches 150° C., a digital value 663 is generated in the microprocessor by processing and converting the resistance signal generated by the sensor. Corresponding to the digital value, the microprocessor generates 1080 (i.e. 90×12) pulses, so that the pointer of the display unit is rotated by 90 degrees (i.e. 6 grids) relative to the scale, reaching the upper limit of the warning zone (i.e. the end of the warning zone).

It can be seen that in this example, with respect to the signal collected by the sensor, the digital value is converted into the pivot angle of the pointer in a non-linear manner based on the first mapping generated by curve fitting, so that when the detected temperature is 110° C. that requires staring the warning, the pointer can pivot to the starting point of the warning zone at 75 degrees, and activate the corresponding function symbol or icon at this time to make it flash.

Specifically, the display control method of the present invention lies in performing segmented linear interpolation (segmented simulation) for the digital value (A/D conversion value) associated with the sensor signal, so that even if the differences between adjacent digital values (being 3452, 3008, 2398, 2024, 1756, 1511, and 663 in this example) are different, regular (especially equi-different) control signals can be generated (0, 180, 360, 540, 720, 900, and 1080 pulses in this example), so that the pointer of the display unit can rotate in a smooth manner and point to the warning zone when the sensor signal (measurement value of the sensor) reaches the preset value.

### Example 2

| | | Sensor | Pull-up | Divided | A/D | |
|---|---|---|---|---|---|---|
| | Temperature | signal | resistor | voltage | conversion | Number |
| | (° C.) | SR (Ω) | PR (Ω) | DV (V) | value | of pulses |
| Warning | 40 | 1609.7 | 300 | 2.7816 | 3452 | 0 |
| temperature | 60 | 830.6 | 300 | 2.4244 | 3008 | 15 * 12 = 180 |
| 120-150° C. | 80 | 424.1 | 300 | 1.9328 | 2398 | 30 * 12 = 360 |
| | 90 | 306.9 | 300 | 1.6688 | 2071 | 45 * 12 = 540 |
| | 100 | 225.3 | 300 | 1.4154 | 1756 | 60 * 12 = 720 |
| | 120 | 104.4 | 300 | 0.8519 | 1057 | 75 * 12 = 900 |
| | 150 | 58 | 300 | 0.5346 | 663 | 90 * 12 = 1080 |

This example is similar to the above Example 1, except that when the temperature measured by the sensor is 120° C. the pointer of the display unit starts to enter the warning zone. At this time, the sensor generates a 104.4Ω resistance signal. After processing and converting the signal, the microprocessor of the control unit generates a digital value 1057. Corresponding to the digital value, the microprocessor generates 900 pulses, so that the pointer of the display unit is rotated by 75 degrees relative to the scale, reaching the lower limit or starting point of the warning zone.

In this example, with respect to the signal collected by the sensor, the digital value is converted in a non-linear manner into an angle in which the pointer needs to pivot on the basis of the second mapping generated by the curve fitting, so that when the detected temperature is 120° C., the pointer can pivot 75° C.

The control unit of the present invention processes the sensor signal to generate a corresponding digital value (A/D conversion value), and converts the digital value based on a desired or required pivot angle of the pointer to generate a control signal for the pointer of the display unit, so that the pointer can point to the warning zone of the scale of the display unit in correspondence to the type of the sensor signal, when the sensor signal reaches the warning value range.

More specifically, in the present invention, the control unit is configured to convert the current sensor signal selected by the user into a corresponding digital value, and convert the digital value into a control signal corresponding to the desired pivot angle of the pointer in a non-linear manner based on the type of the current sensor signal selected by the user. In particular, the control unit is configured to convert the digital value into a control signal corresponding to the desired pivot angle of the pointer by way of curve fitting.

In practice, after determining the parameter or sensor signal type that needs to be monitored, the user can remove the plug 6 at the bottom of the housing 4 of the display gauge to operate the selector 3, e.g. turn the potentiometer to a predetermined position to inform the control unit 2 of the function or sensor signal type that needs to be displayed. Then the user can put the plug 6 back to close the housing 4, thereby protecting the display unit 1 and the control unit 2.

Subsequently, when the display gauge is powered on, the function symbol 113 corresponding to the selected function or sensor signal type on the dial 11 will be lightened, and the pointer 12 will rotate as a function of changing value of the sensor signal, point to the warning zone of the scale of the dial 11 when the value reaches a predetermined threshold, and the corresponding function symbol or icon is activated to flash it at this time, thereby sending a warning message to the user.

The description is for illustrative purposes only, and is not intended to limit the scope of the present invention in any way. Therefore, those skilled in the art should understand that various modifications can be made to the disclosed embodiments without departing from the full and reasonable scope and spirit of the present invention. Other aspects, features and advantages will become apparent from the drawings and appended claims.

1. A display gauge, in particular used in a cab of a motor vehicle, comprising a display unit and a control unit, the display unit having a stationary warning zone, the control unit being connectable with different types of sensors to receive sensor signals, wherein the display gauge further comprises a coded selector that can be operated by a user, the selector being electrically connected to the control unit to transmit to the control unit a signal indicative of a type of a current sensor signal selected by the user, and the control unit controls display of the display unit according to a value of the current sensor signal, so that a state in which the value of the current sensor signal reaches a warning value range can be displayed through the warning zone regardless of the type of the sensor.

2. The display gauge according to claim 1, characterized in that the display unit comprises a dial and a pointer, the dial is provided with a scale including the warning zone, and the pointer can be driven by the control unit so as to point to the warning zone when the current sensor signal is within the warning value range, wherein the pointer is a physical pointer and the scale is a physical scale.

3. The display gauge according to claim 2, characterized in that the scale comprises an arc line and scale lines extending in a radial direction to divide the arc line into a plurality of sections, wherein the section at the end in a clockwise direction forms the warning zone.

4. The display gauge according to claim 1, characterized in that the control unit is configured to convert the current sensor signal into a corresponding digital value, and convert the digital value into a control signal corresponding to a desired pivot angle of the pointer in a nonlinear manner based on the type of the current sensor signal selected by the user.

5. The display gauge according to claim 4, characterized in that the control unit is configured to convert the digital value into the control signal corresponding to the desired pivot angle of the pointer by curve fitting.

6. The display gauge according to claim 2, characterized in that the dial is composed of a dark transparent Elm, which is provided with a plurality of functional symbols indicative of the types of sensor signals, wherein these functional symbols can be lightened in correspondence to the type of current sensor signal selected by the user.

7. The display gauge according to claim 6, characterized in that the control unit comprises a plurality of light guides oriented towards the functional symbols for lightening the corresponding functional symbol.

8. The display gauge according to claim 1, characterized in that the control unit comprises a microprocessor, which comprises a plurality of software processing modules fir separately processing different sensor signals, and is configured to receive signals from the selector to run a software processing module corresponding to the current sensor signal.

9. The display gauge according to claim 6, characterized in that the control unit is composed of an upper circuit board and a lower circuit board which are signal-connected with each other, wherein the light guide and a driving module for driving the pointer to rotate are arranged on the upper circuit board, and the microprocessor and the coded selector are arranged on the lower circuit board.

10. The display gauge according to claim 9, characterized in that the display unit and the control unit are encapsulated in a housing, in particular an integrally injection molded housing, which has an opening aligned with the selector and being closable by a removable plug.
